(19) United States
(12) Patent Application Publication
(10) Pub. No.: US 2019/0061286 A1
(43) Pub. Date: Feb. 28, 2019

(54) PRODUCTION OF A FIBER-REINFORCED THERMOPLASTIC PIPE

(71) Applicant: DIEHL AVIATION LAUPHEIM GMBH, Lauphem (DE)

(72) Inventors: STEFAN GIEHL, TRIPPSTADT (DE); SVEN UTIKAL, BURGRIEDEN (DE); FLORIAN HESSELBACH, BLAUSTEIN (DE); MARTIN ZABOR, ULM (DE)

(21) Appl. No.: 16/106,328

(22) Filed: Aug. 21, 2018

(30) Foreign Application Priority Data
Aug. 22, 2017 (DE) 102017007914.5

(51) Int. Cl. B29C 70/46

(52) U.S. Cl. CPC B29C 70/462; B29K 2101/12; B29C 70/465

(57) ABSTRACT

In a method for producing a pipe made of a fiber-reinforced thermoplastic material, two workpieces of the material are provided. The workpieces are introduced into a tool having a core and two part molds surrounding the core. The workpieces are heated and shaped between the core and the part molds to give a structural part of the pipe. The core is removed from the structural parts, the structural parts being held on the part molds, and joining regions of the structural parts are oriented towards one another. The structural parts are joined to one another in the joining regions to form the pipe. The pipe is released from the part molds, wherein the part molds are moved away from one another after shaping in order to remove the core, and are then moved back together in order to orient the structural parts towards one another.

### CROSS-REFERENCE TO RELATED APPLICATION

This application claims the priority, under 35 U.S.C. § 119, of German application DE 10 2017 007 914.5, filed Aug. 22, 2017; the prior application is herewith incorporated by reference in its entirety.

### BACKGROUND OF THE INVENTION

### Field of the Invention

The invention relates to a method for the production of a pipe made of a fiber-reinforced thermoplastic material.

Air-conditioning pipes made of thermoplastic semi-finished products reinforced with long fibers are known in practice. At present, these are thermoformed using a two-part tool in order to obtain half-shells. In this context, once the semi-finished product has been heated, a punch is pressed into the cavity prior to demolding. The shaped shells are then introduced into a welding tool. Since the semi-finished product is very thin, it is difficult to secure in the tool in a reliable and contour-accurate manner. Incorrect positioning of the half-shells results, after welding, in deviations in the desired contour.

Published, European patent application EP 3 305 496 A1, corresponding to U.S. patent publication No. 2018/016207, discloses a method for the production of a fiber-reinforced thermoplastic hollow body. For that purpose, workpieces of a thermoplastic material are introduced into a tool, surrounding a core. The core is formed from a pulverulent and granular material. After shaping of the hollow body, the material of the core is removed through holes in the hollow body. Further methods for the production of shaped parts made of a fiber-reinforced composite material are known from published, German patent applications DE 10 2014 004 157 A1, DE 10 2015 120 429 A1 and DE 10 2012 020 184 A1 and German patent DE 44 23 642 C1.

### SUMMARY OF THE INVENTION

The present invention has the object of specifying an improved production method for a fiber-reinforced thermoplastic pipe.

The method serves for the production of a pipe made of a fiber-reinforced thermoplastic material. In the method, at least two workpieces of the material are provided. All of the workpieces are introduced into a tool. This tool has at least one core and at least two part molds surrounding the core. The workpieces are heated. Each of the heated workpieces is shaped between the core and the part molds—by pressing the core and the part molds together—to give a structural part of the pipe. The core is removed from the structural parts. At that stage, the structural parts are or remain held on the part molds. Respective joining regions of the structural parts are oriented towards one another with the aid of the part molds. Here, too, the structural parts remain, unchanged, held on the part molds. The structural parts are joined to one another in the joining regions to give the pipe. The structural parts, or the resulting pipe, still remains, unchanged, held on the part molds. Only at this point is the pipe (as the assembly of joined structural parts) released from the part molds.

According to the invention, the part molds are moved away from one another after shaping. The core is then removed. The part molds are then moved back together and, in so doing, the joining regions of the structural parts are oriented towards one another. During both movements, the structural parts are or remain held on the part molds. In particular, both movements are on exactly the same path but in opposite directions. This makes it particularly simple to remove the core from the rest of the tool. In the event that the shaping in the closed tool is carried out such that, after shaping, the joining regions of the structural parts are already oriented correctly, it is sufficient to simply move them apart and, with the identical opposite movement, back together in order to once again orient the structural parts exactly after removal of the core. This is performed for example by linear guiding of one of the part molds while the second part mold remains positionally fixed, in the case of exactly two part molds being present. In particular, this is performed when the tool or the part molds are clamped in a press, in which case the movement path—in particular a straight line—is structurally defined by the press.

“Surround” is to be understood as meaning that the sum of the part molds surrounds the core(s). The tool is in particular a press tool since the workpiece is pressed between the core and the part molds for shaping. The heating takes place at least for the shaping procedure. The workpieces are heated inside and/or outside the tool, and are in particular already heated or at least preheated outside the tool by means of infrared lamps. In particular, at least part of the tool, and in particular the entire tool, is heated, such that the workpiece is (partially) heated and/or held at least in the hot state by the tool, and/or excessively rapid cooling of the workpieces is prevented by the heated tool. In particular, there is in each case one workpiece between the core and one of the part molds. In particular, in each case one structural part is held on each one of the part molds. In particular, there is therefore one workpiece per part mold. The stated orientation is to be understood as meaning that the part mold is moved and, therewith, the structural part of the pipe that is held on the part mold. Thus, the part mold forms a support or holder or manipulator for the structural part. From the shaping of the workpiece to form the structural part until the release of the pipe, the workpieces or structural parts or the finished pipe remain, unchanged or uninterrupted, in the respective part mold.

Thus, according to the invention, pipes made from a thermoplastic fiber-reinforced semi-finished product are created by thermoforming. This involves a two-step process in order to obtain a pipe without re-clamping. In a first process step, the structural parts are formed. In a second process step, the structural parts are joined to form the pipe. According to the invention, it is possible to fully automate the shaping of the workpieces and the joining of the structural parts to form the pipe without re-clamping of the structural parts. By not re-clamping, the structural parts are always correctly positioned with respect to one another, and distortion of the finished component or pipe is minimized. The method results in increased efficiency by pressing at least two structural parts in one pass.

The core is made of a heat-resistant and pressure-resistant material in order to withstand the processing temperatures and pressures. The core is preferably made of a metallic material; owing to the long residence time, steel alloys and nickel-based alloys are of particular relevance. However, aluminum cores are also possible. Typically, the core is a milled part. In that context, the core is solid or a hollow structure. For controlling the temperature of the core, it is possible to provide heating devices such as heating cartridges. External heating using a heat transfer fluid is also possible. The geometry of the core follows the internal contour of the subsequent component, and the surface quality of the core defines the subsequent internal surface of the air-conditioning pipe. Therefore, in order to minimize flow losses, a high-quality surface is desired.

In one preferred embodiment, use is made of exactly two part molds in the form of half-shells in order to shape, together with exactly one core, exactly two workpieces into two structural parts in the form of pipe halves. The mold is therefore a three-part mold having two part molds and a core. The pipe is composed in two parts of two structural parts. According to this embodiment, the adjustment requirement for the joining regions of the structural parts is minimal and the tool is particularly simple to manipulate owing to the low number of individual parts.

In one preferred embodiment, the structural parts are joined by welding and/or adhesive bonding in the joining regions to give the pipe. Fiber-reinforced thermoplastic material can be joined particularly well and simply by welding or adhesive bonding. Adhesive bonding is in particular heat-assisted.

In one preferred embodiment, at least one of the structural parts is held on one or more part molds with the aid of a negative pressure. The negative pressure is in particular a vacuum. In particular, all of the structural parts are held with the aid of negative pressure. Using negative pressure to hold a structural part on a (part) mold is a routine method which is simple, cost-effective and reliable, and so in this regard the entire method has the corresponding advantages.

In one preferred embodiment, during shaping, flange parts are formed on the structural parts. The flange parts have the joining region or form the joining region or form part of the joining region. The structural parts are then joined to form a flange by joining the flange parts. Corresponding flange parts make it possible to join the structural parts in a manner which is particularly simple and reliable, or stable. The joined flange parts result in a complete flange on the pipe. In general, such a flange is not disruptive.

In one preferred embodiment, the structural parts are machined after shaping. The machining serves to provide and/or machine the joining region. Moreover, the machining is carried out before the structural parts are oriented towards one another. In particular for the case in which flangeless pipes are to be created, it is possible for the joining regions to be again precisely matched to one another in order to ensure an exact-fitting and thus reliable, or stable, join between the joining regions, and thus a stable pipe.

In one preferred embodiment, as joining region, there is provided an overlap region of two structural parts that are to be joined. A corresponding overlap permits full-area adhesive bonding or welding, resulting in a particularly strong and durable join between the structural parts. In that context, the overlap can—for example in contrast to a flange projecting perpendicularly from the respective pipe section—run in particular tangentially to the respective section of the pipe.

In one preferred variant of this embodiment, the structural parts, for joining in the joining region, are pressed against one another with the aid of a pressure means. Thus, the structural parts that are respectively to be joined are also pressed against one another over the full area of their overlap region, which also results in a particularly secure and reliable join between the structural parts in the overlap region or joining region. An appropriate pressure means is for example a pressure ram or a pressurized internal hose. This makes it possible to exert pressure on the joining region in a particularly simple and effective manner. The pressure means also has, in particular, a counterpart which serves as a bearing surface for exerting pressure, in particular the counterpart is a section of one or more part molds.

In one preferred variant of this embodiment, compressed air is used as the pressure means or at least part of the pressure means (for example in conjunction with the internal hose). The compressed air serves to establish an increased pressure in the interior of the pipe that is to be joined. A counter-pressure is provided by at least one of the part molds. Since the part molds surround the structural parts or the pipe or the components thereof, it is thus possible to exert external pressure or counter-pressure on the pipe. A compressed air increased pressure in the interior of the pipe is easily established, either solely by compressed air or by compressed air which is introduced into an internal hose inside the pipe. It is thus possible to realize a pressure means in a correspondingly simple manner.

In one preferred embodiment, a pipe in the form of an air-conditioning pipe for a vehicle is produced. The vehicle is in particular an aircraft. Thus, the advantages of the method can also be used for the production of pipes for vehicles and/or aircraft.

In one preferred embodiment, a laminar workpiece is provided. The workpiece is in particular planar, in particular in the form of a panel. Laminar workpieces are particularly easy to provide and also particularly easy to machine.

In one preferred variant of this embodiment, a workpiece having a thickness of 0.05 mm to 0.6 mm is provided. In particular, the thickness is between 0.08 mm and 0.5 mm. In particular, the thickness is between 0.1 mm and 0.4 mm. In particular, the thickness is between 0.15 mm and 0.25 mm, in particular between 0.2 mm and 0.25 mm.

In one preferred embodiment, at least one of the workpieces is provided as a laterally held, in particular fiber-reinforced, film. In particular, the film is tensioned in planar fashion, the tensioning in the plane of the film being effected by pulling laterally outwards. For tensioning, use is made in particular of a spring device that pulls away from the film in the planar direction. The film is in particular provided on a roll or taken therefrom, as a semi-finished product. A corresponding film is particularly easy to use in the method.

In one preferred embodiment, at least one of the workpieces is heated outside the tool and/or during transport to the tool. The workpieces, in particular in the form of a thermal semi-finished product, are thus heated or at least preheated outside the tool. This outside heating is effected in particular by means of at least one infrared lamp. Thus, it is not necessary for all of the heating of the workpiece to be effected using the tool. It is for example adequate for the tool to provide sufficient heat to maintain the already preheated workpiece at an appropriate required temperature. This allows the tool to be of simpler construction.

The invention is based on the following findings, observations or considerations and also includes the following embodiments. The embodiments are here also referred to as “the invention”, partly for the purposes of simplification. The embodiments can here also contain parts or combinations of the above-stated embodiments or correspond to them and/or possibly also include embodiments which have not yet been mentioned.

According to the invention, the pressing process involves, in particular, the manufacture of fiber-reinforced thermoplastic pipes from half-shells.

The invention is based on the concept of manufacturing air-conditioning pipes from a thermoplastic fiber-reinforced semi-finished product by thermoforming. This involves a two-step process in order to obtain a pipe without re-clamping: 1. shaping the semi-finished products, 2. welding/adhesive bonding of the semi-finished products in the same tool.

According to the invention, in particular:

1. Two semi-finished products are brought to above the softening point under a heating panel (infrared, IR).

2. The semi-finished products are brought into a press (the path between the press and the IR panel must be heated) and are placed above and below the core.

3. The press having the three-part, heated tool is closed and a vacuum is applied between the cavities and the semi-finished products.

(3.1 A trimming procedure takes place (optional for flangeless pipes)).

4. The press is opened and the core removed (vacuum remains applied).

5. The press is closed again, a joining pressure (vacuum, clamping or pressurized internal hose—only for flangeless pipes) is applied and the welding/adhesive bonding zone is heated.

6. The press is opened and the item is de-molded.

According to the invention, there is potential for full automation of the half-shell pressing and the welding procedure without re-clamping of the half-shells. By not re-clamping, the half-shells are always correctly positioned with respect to one another, and thus distortion of the component is minimized. This results in increased efficiency by pressing two half-shells in one pass.

Other features which are considered as characteristic for the invention are set forth in the appended claims.

Although the invention is illustrated and described herein as embodied in a production of a fiber-reinforced thermoplastic pipe, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a sequence scheme for the production of a pipe with a flange according to the invention; and

FIG. 2 is a sequence scheme for the production of a flangeless pipe.

### DETAILED DESCRIPTION OF THE INVENTION

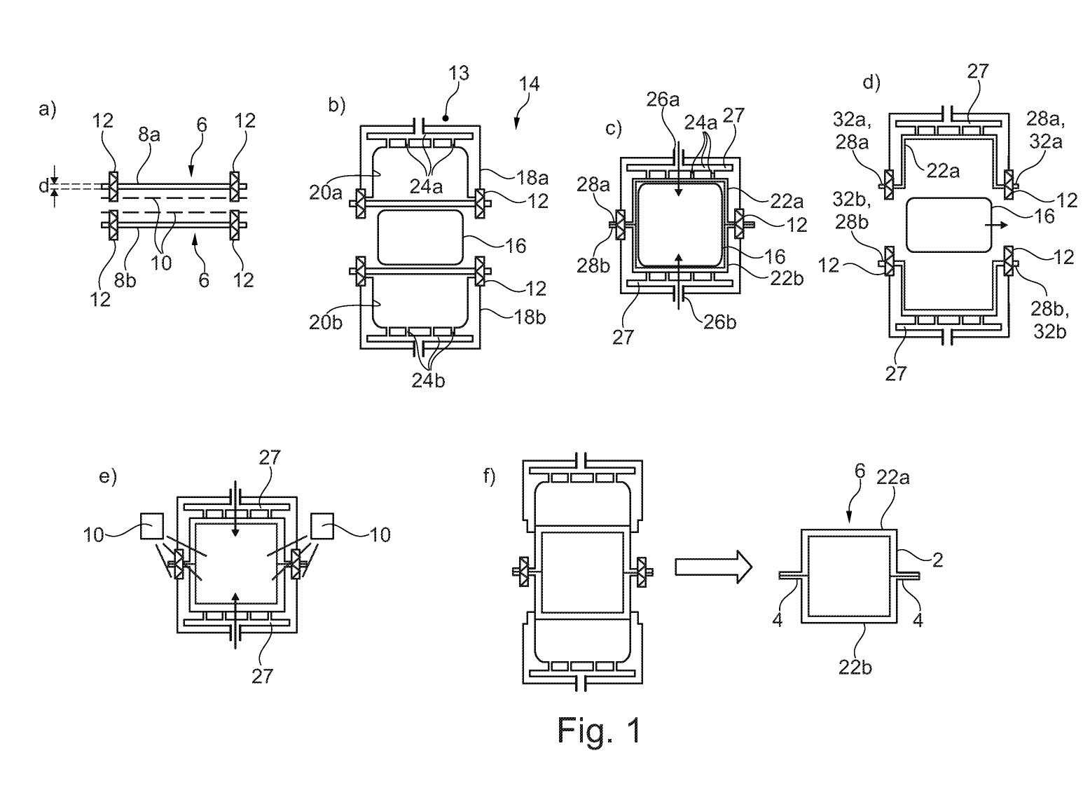

FIG. 1 illustrates a method for the production of a pipe 2 with a flange 4 from a fiber-reinforced thermoplastic material 6.

In step a) two workpieces 8a, 8b made of the material 6 are provided. The workpieces 8a,b are heated to above the softening point by means of a heating device 10, which here is indicated only by dashed lines. To that end, the heating device 10 forms a heating panel (infrared, IR). The workpieces 8a, 8b in the form of two semi-finished products are thus conveyed under the heating panel. Each of the workpieces 8a, 8b is a film and is held laterally or at its periphery by a holding device 12 that is depicted symbolically as a spring. The workpieces 8a, 8b are laminar with a thickness d of in this case 0.1 mm.

In step b) the workpieces 8a, 8b are conveyed into a tool 14 which is held in this case in a press 13 that is not illustrated in greater detail. The path between the heating device 10 (IR panel) and the tool 14 is heated. In the tool 14, the workpieces 8a, 8b are placed above and below a core 16 of the tool 14. The tool 14 is in three parts and is heated and contains as first part the core 16 and as second and third parts two part molds 18a, 18b. In FIG. 1, the core 16 is illustrated only schematically, and at different scales, in order to clarify the method.

In step c) the press 13 with the heated tool 14 is closed (indicated by arrows) and a negative pressure 27 in the form of a vacuum is applied between the semi-finished products or workpieces 8a, 8b and the cavities 20a, 20b of the part molds 18a, 18b. On closing, the workpieces 8a, 8b are shaped into structural parts 22a, 22b of the pipe 2—in each case one between the core 16 and one of the part molds 18a, 18b. Flange parts 28a, 28b are in this case formed on the structural parts 22a, 22b. Thus, in the example, only two part molds 18a, 18b in the form of half-shells are provided in order to shape two workpieces 8a, 8b into two structural parts 22a, 22b in the form of pipe halves. The flange parts 28a, 28b then form joining regions 32a, 32b which are subsequently joined together in order to join the two structural parts 22a, 32b. In this context, the heated tool 14 means that the workpieces 8a, 8b are heated or retain their prior heating. The structural parts 22a, 22b are held on the respective part molds 18a, 18b in a conventional manner, not explained in greater detail here, by application of the negative pressure 27 in the form of a vacuum between the structural parts 22a, 22b and the cavities 20a, 20b. In order to generate the negative pressure 27, the part molds 18a, 18b contain suction or negative pressure ducts 24a, 24b which lead to a respective negative pressure port 26a, 26b.

In step d) the press 13 is opened and the core 16 is removed, as indicated by an arrow. The negative pressure 27 in the negative pressure ducts 24a, 24b remains, and the structural parts 22a, 22b remain suctioned or held in the part molds 18a, 18b.

In step e) the press 13 is closed again. The structural parts 22a, 22b remain held in the part molds 18a, 18b also during the closing procedure. In the process, the flange parts 28a, 28b or joining regions 32a, 32b are oriented towards one another. This takes place because the press 13 is opened and closed along the same path and the joining regions have already been created with the correct orientation when produced in step c). The flange parts 28a, 28b are pressed against one another with the aid of the press 13 or the tool 14 and are heated and thus welded by irradiation by a further heating device 10 (in dotted lines). Thus, the structural parts 22a, 22b are joined, in the joining region 32a, 32b, to form the pipe 2—in this case by welding but alternatively or additionally by adhesive bonding. The structural parts 22a, 22b are joined by joining the flange parts 28a, 22b. The re-closing of the press 13 is again symbolized by two arrows. In this case, the flange parts 28a, 22b form a welding/adhesive bonding zone which is heated. Thus, the part molds 18a, 18b are moved away from one another after shaping in order to remove the core 16, and are then moved back together in order to orient the structural parts 22a, 22b towards one another, the structural parts 22a, 22b being held, or remaining, on the part molds 18a, 18b.

In step f) the press 13 is once again opened so that the now finished pipe 2 can be removed, which is indicated by an arrow. It is now also possible to remove the holding devices 12.

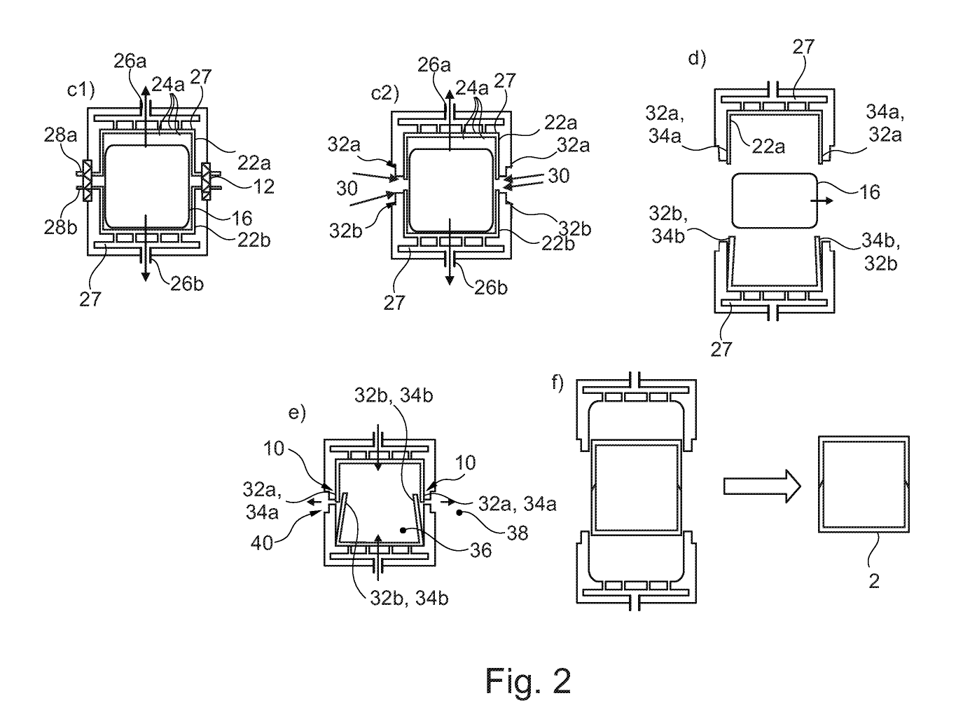

FIG. 2, which largely matches FIG. 1, shows the manufacture of a pipe 2 with no flange, wherein steps a), b) and c) match those of FIG. 1 and are carried out identically.

Step c1) shows a moment, following step c) from FIG. 1, when after shaping of the workpieces 8a, 8b to give the structural parts 22a, 22b these are already held on the part molds 18a, 18b by the negative pressure 27, but the tool 14 has already been slightly opened again, as indicated by movement arrows.

In another subsequent step c2) a trimming procedure takes place at the locations indicated by arrows 30. The trimming procedure involves separating the flange parts 28a, 28b from the rest of the structural parts 22a, 22b. This represents machining of the structural parts 22a, 22b which takes place after shaping of the latter and before they are once again oriented towards one another. The machining creates alternative joining regions 32a, 32b which are now located, as seen in the figure, at the lower rim of the structural part 22a and at the upper rim of the structural part 22b. Thus, the structural parts 22a, 22b are machined after shaping in order to provide the joining region 32a, 32b before they are oriented towards one another. Thus, in this case an overlap region 34a, 34b of the two structural parts 22a, 22b that are to be joined is created as the joining region 32a, 32b.

In step d), matching FIG. 1, the core 16 is removed from the tool 14 or press 13.

In step e), matching FIG. 1, the structural parts 22a, 22b are oriented with respect to the now alternative joining regions 32a, 32b, which in this case are overlap regions 34a,b of the structural parts 22a,b. By applying an increased pressure in the internal region 36 of the pipe 2 that is to be created, and a negative pressure or vacuum in the exterior 38, the joining regions 32b are respectively pressed outwards, that is to say towards the joining regions 32a of the structural part 22a, or towards the part molds 18a, 18b, in which situation the structural part 22a braces against the part molds 18a, 18b. Thus, increased pressure in the internal region 36 and negative pressure or vacuum in the external region 38 together form a pressure means 40 for pressing the overlap regions 34a, 34b or joining regions 32a, 32b against one another. Here, the direction of the pressure is indicated symbolically by arrows. Here too, the heating of the welding/adhesive bonding zone (joining region 32a, 32b), or the welding and/or adhesive bonding of the structural parts 22a, 22b to give the finished pipe 2, is brought about by means of a heating device 10 which once again is indicated only symbolically. The structural parts 22a, 22b, for joining in the joining region 32a, 32b, are pressed against one another with the aid of the pressure means 40. Here, compressed air is used as part of the pressure means 40, wherein the compressed air serves to establish an increased pressure in the internal region 36 of the pipe 2 that is to be joined, and a counter-pressure is also provided by at least one of the part molds 18a, 18b.

In step f) similarly to FIG. 1 above, the press 13 is opened and the pipe 2 is removed in the direction of the arrow.

The method serves to produce pipes 2 in the form of air-conditioning pipes for an aircraft as vehicle. The work pieces 8a, 8b may already be heated outside the tool 14 and during transport to the tool 14.

The following is a summary list of reference numerals and the corresponding structure used in the above description of the invention:
2 Pipe
4 Flange
6 Material
8a,b Workpiece
10 Heating device
12 Holding device
13 Press
14 Tool
16 Core
18a,b Part mold
20a,b Cavity
22a,b Structural part
24a,b Negative pressure duct
26a,b Negative pressure port
27 Negative pressure
28a,b Flange part
30 Arrow
32a,b Joining region
34a,b Overlap region
36 Internal region
38 Exterior
40 Pressure means
d Thickness

1. A method for producing a pipe made of a fiber-reinforced thermoplastic material, which comprises the steps of:
providing at least two workpieces formed of the fiber-reinforced thermoplastic material;
introducing all of the workpieces into a tool, the tool having at least one core and at least two part molds surrounding the core;
heating the workpieces resulting in heated workpieces, each of the heated workpieces is shaped between the core and the part molds to form a structural part of the pipe;
removing the core from structural parts by moving the part molds away from one another after shaping in order to remove the core, and are then moved back together in order to orient the structural parts towards one another, the structural parts being held on the part molds;
orienting joining regions of the structural parts towards one another with an aid of the part molds;
joining the structural parts to one another in the joining regions to form the pipe; and
releasing the pipe from the part molds.

2. The method according to claim 1, which further comprises using the two part molds in a form of half-shells to shape, together with the core, the two workpieces into the two structural parts in a form of pipe halves.

3. The method according to claim 1, which further comprises joining the structural parts by welding and/or adhesive bonding in the joining regions to form the pipe.

4. The method according to claim 1, which further comprises holding at least one of the structural parts on the part molds with an aid of a negative pressure.

5. The method according to claim 1, which further comprises during a shaping step, forming flange parts on the structural parts, the flange parts have or form the joining regions or form part of the joining regions, and the structural parts are joined to form a flange by joining the flange parts.

6. The method according to claim 1, which further comprises machining the structural parts after shaping in order to provide and/or machine the joining regions before they are oriented towards one another.

7. The method according to claim 1, wherein the joining regions are each provided as an overlap region of the two structural parts that are to be joined.

8. The method according to claim 7, which further comprises pressing the structural parts, for joining in the joining regions, against one another with an aid of a pressure source.

9. The method according to claim 8, which further comprises using compressed air as at least part of the pressure source, wherein the compressed air serves to establish an increased pressure in an interior of the pipe that is to be joined, and a counter-pressure is provided by at least one of the part molds.

10. The method according to claim 1, which further comprises producing the pipe in a form of an air-conditioning pipe for a vehicle.

11. The method according to claim 1, which further comprises providing a laminar workpiece as at least one of the workpieces.

12. The method according to claim 12, wherein the workpieces have a thickness of 0.05 mm to 0.6 mm.

13. The method according to claim 1, which further comprises providing at least one of the workpieces as a laterally held film.

14. The method according to claim 1, which further comprises heating at least one of the workpieces outside the tool and/or during transport to the tool.
